(19) United States
(12) Patent Application Publication
(10) Pub. No.: US 2025/0102185 A1
(43) Pub. Date: Mar. 27, 2025

(54) FOLDABLE SPACE HEATER

(71) Applicant: Matthew Slack, Las Vegas, NV (US)

(72) Inventor: Matthew Slack, Las Vegas, NV (US)

(73) Assignee: Matthew Slack, Las Vegas, NV (US)

(21) Appl. No.: 18/472,287

(22) Filed: Sep. 22, 2023

(51) Int. Cl. F24H 3/04; H05B 3/06; H05B 3/62

(52) U.S. Cl. CPC F24H 3/0417; H05B 3/06; H05B 3/62; F24H 2250/02

(57) ABSTRACT

A foldable space heater comprises a lower housing, a telescopic pole, and an upper housing. The upper housing connected with the telescopic pole via a first hinge joint. The lower housing connected with the telescopic pole via a second hinge joint. An electric wire passed through the lower housing towards the upper housing via the telescopic pole to avoid tripping of the electric wire. The upper housing includes a heating element, and a fan. The heating element connected with the electric wire to convert electric energy into heat. The fan ventilates the radiations associated with the heat. The telescopic pole makes the foldable space heater extendable and retractable. The first hinge joint and second hinge joint makes the foldable space heater collapsible. A user interface provided to operate the foldable space heater. The foldable space heater also equipped with wireless charging.

### FIELD OF THE INVENTION

The present invention generally relates to systems or devices used for heat and mass transfer. More specifically, the present invention relates to systems and devices used for achieving space heating using convection as a dominant mode of heat transfer.

### BACKGROUND OF THE INVENTION

Space heaters are heating devices that are used to provide heating for small to medium-sized spaces, in contrast to central heating, which is used for heating several spaces, such as rooms and offices distributed over a relatively larger area. Space heaters are predominantly electrically powered and can be of fan heaters, ceramic, infrared, and oil-filled construction. The predominant mode of heat transfer in space heaters is convection. Moreover, in most of the aforementioned constructions of space heaters, heating is fan-assisted, though space heaters not deploying fans are also widely used because of their better efficiency. However, space heaters that do not use fan-assisted heating take longer to achieve the desired temperatures.

In addition, in either of the constructions mentioned above, there exists a trade-off between the heating capacity of the space heaters and their portability. While some commercially available space heaters attempt to provide a compromise between the two conflicting aspects, they still need to improve on other design issues such as stability, cost, and electrical safety. Some of the solutions in that regard are discussed below:

US20190104764A1 discloses a foldable heater of an electronic vaping device that includes a first plurality of U-shaped segments arranged in a first direction and defining a first side of the heater and a second plurality of U-shaped components set in the first direction and defining a second side of the heater. A heating element in the electronic vaping device produces vapor from pre-vapor formulation. The second side is substantially parallel to the first side. The heater also includes a first lead portion and a second lead portion. The first plurality of U-shaped segments, the second plurality of U-shaped components, the first lead portion, and the second lead portion are a single integral member.

Although, the heater disclosed in the above prior US'764 can provide heat. In addition, the disclosed heater is also extendable the foldable in the above prior art produces vapor from pre-vapor formulation. However, the heater in the above prior art fails in the placement of the heater on both a wall surface and a ground surface. Further, the heater in the above prior art is also unable to adjust at various angles per the desire or requirement of a user(s).

US20220151031A1 discloses a heater that includes a folded heater wire for generating heat, a first insulator provided on the heater wire to deliver insulation to the heater wire, a metal sheath supplied so as to be in contact with the first insulator providing as a casing to the heater wire, a first insulating member arranged parallel to a first end part of the heater wire taken out from a first end part of the metal sheath, a second insulating member arranged parallel to the first insulating member and parallel to a second end part of the heater wire taken out from the first end part of the metal sheath, a second insulator in contact with the first and the second insulating members and the metal sheath, and a lid member covering the first insulating member, the lid member being in connection with the metal sheath, the first and the second insulating members via the second insulator, and arranged parallel to the first and the second insulating members and the metal sheath.

However, the heater disclosed in the above prior US'031 is capable of providing heat to the surroundings. In addition, the above prior art provides the insulation to the heating wire. However, the heater in the above prior art fails in the placement of the heater on both a wall surface and a ground surface. In addition, the disclosed heater is also extendable and foldable, however the heater in the above prior art does not describe the elimination of the problems with the change of location of the center of gravity during folding or extension of the heater. Further, the heater in the above prior art is also unable to adjust at various angles per the desire or requirement of a user(s).

Therefore, there is a need in the art for a space heater that does not suffer from the deficiencies above.

### OBJECTS OF THE INVENTION

Some of the objects of the invention are as follows:

An object of the present invention is to develop a foldable space heater capable of heating a space or a room.

Another object of the present invention is to develop a foldable space heater that is collapsible and extendible.

Another object of the present invention is to develop a foldable space heater that enables a user(s) to adjust the temperature of the room or the space as per the comfort of the user(s).

Another object of the present invention is to develop a heater that eliminates the uncertainty in the center of gravity of the heater.

Another object of the present invention is to develop a foldable space heater that provides a wireless charging dock on an electronic device associated with the foldable space heater.

Another object of the present invention is to develop a foldable space heater that can be placed both on a ground surface and a wall surface.

Another object of the present invention is to develop a foldable space heater which is light in weight.

Another object of the present invention is to develop a foldable space heater that is lockable after folding the heater.

Another object of the present invention is to develop a foldable space heater that has design features to prevent short circuits in electrical wiring of the foldable space heater.

Another object of the present invention is to develop a foldable space heater that has variable height.

Another object of the present invention is to develop a foldable space heater that is allowed to be placed at any angle with respect to the surface.

Yet another object of the present invention is to develop a foldable space heater that is portable.

### SUMMARY OF THE INVENTION

According to an embodiment of the present invention, there is provided a foldable space heater. The proposed invention comprises a lower housing to be placed over a surface. Moreover, the lower housing of the foldable space heater is further comprising a base portion facing towards the surface, a top portion located at a predetermined height from the base portion, and a cavity crafted over the top portion. The heater further comprises a telescopic pole extending upwards from the lower housing. The telescopic pole further comprises a top end attached to a lower side of an upper housing via a first hinge joint. The first hinge joint enables the upper housing to pivot with respect to the telescopic pole. Further, a bottom end is attached to the lower housing via a second hinge joint. The second hinge joint enables the telescopic pole to pivot with respect to the lower housing towards the cavity, causing the upper housing to contact the lower housing.

In one embodiment of the invention, the surface on which the lower housing is placed on a ground surface or a wall surface.

In one embodiment of the invention, the cavity is a T-shaped cavity or an I-shaped cavity, and at least a length, a width, and a depth of the cavity is larger than at least a length, a width, and a depth of the telescopic pole when the telescopic pole is in a completely retracted state.

In one embodiment of the invention, the telescopic pole comprises at least a first hollow rod comprising a first hole of a first diameter at a first end, and a second hole of a second diameter at a second end, the first diameter is greater than the second diameter, the first end attached to the lower housing.

In one embodiment of the invention, the telescopic pole further comprises at least a second hollow rod comprising a third hole of a third diameter at a third end, and a fourth hole of a fourth diameter at a fourth end, the third diameter greater than the second diameter, the third end adapted to be inserted into the second hole.

In one embodiment of the invention, the upper housing includes a front side, a rear side, a fan, and a heating element.

In one embodiment of the invention, a plurality of grills is crafted over the front side to allow heat transfer from the heating element to a space or a room.

In one embodiment of the invention, a plurality of holes is crafted in the rear side to ventilate the hot air to the space, the room, or the ambient via the fan.

In one embodiment of the invention, an inverted cavity is crafted over a lower end of the rear side to attach and/or movement of the first hinge joint.

In one embodiment of the invention, a cut section is crafted over the front side, the cut section equipped with wireless charging.

In one embodiment of the invention, an electronic device is provided over the cut section, the electronic device configured to operate the foldable space heater.

In one embodiment of the invention, a male connector is configured over the telescopic pole, and a female connector is configured over the rear side of the upper portion to lock the heater.

In one embodiment of the invention, an electric wire is passed through the telescopic pole and is electrically connected to the heating element.

In one embodiment of the invention, a plurality of electronic items are placed in the lower housing to maintain a center of gravity of the foldable space heater closer to the surface.

In one embodiment of the invention, the plurality of electronic items comprise a power source and a plurality of resistors.

In one embodiment of the invention, the electronic device comprises a user interface, a rechargeable battery, and a plurality of buttons.

In one embodiment of the invention, the method of using the foldable space heater performs in a best manner by following some steps, which include placing the foldable space heater over a surface wherein the foldable space heater comprises a lower housing which further comprising a base portion facing towards the surface, a top portion located at a predetermined height from the base portion, and a cavity crafted over the top portion. The heater further comprises a telescopic pole, which further comprises a top end attached to a lower side of an upper housing via a first hinge joint. The first hinge joint enables the upper housing to pivot with respect to the telescopic pole. Further, a bottom end attached to the lower housing via a second hinge joint. The second hinge joint enables the telescopic pole to pivot with respect to the lower housing towards the cavity, causing the upper housing to contact the lower housing. Further, separating an upper housing from a lower housing of the foldable space heater. Furthermore, extending the telescopic pole from the lower housing of the foldable space heater. Upon extension of the telescopic pole, tilting the upper housing towards the telescopic pole. Further, providing an electric current to a power source present at the lower housing of the foldable space heater. At last, for maintaining the required temperature, adjusting the temperature of a space or a room from a user interface in an electronic device.

### BRIEF DESCRIPTION OF DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

FIG. 1 illustrates an exploded view of a foldable space heater, in accordance with an embodiment of the present invention;

FIG. 2 illustrates a back-side view of a lower housing of the foldable space heater, in accordance with an embodiment of the present invention;

FIG. 3 illustrates an exploded view of a telescopic pole of the foldable space heater, in accordance with an embodiment of the present invention;

FIG. 4A illustrates an exploded view of an upper housing of the foldable space heater, in accordance with an embodiment of the present invention;

FIG. 4B illustrates a rear view of the upper housing of the foldable space heater, in accordance with an embodiment of the present invention;

FIG. 4C illustrates a front view of the upper housing of the foldable space heater, in accordance with an embodiment of the present invention;

FIG. 5 illustrates an operational view of the foldable space heater, in accordance with an embodiment of the present invention;

FIG. 6 illustrates another operational view at an angle of the foldable space heater, in accordance with an embodiment of the present invention;

FIG. 7A illustrates an isometric view of the foldable space heater about to come in a locked state, in accordance with an embodiment of the present invention;

FIG. 7B illustrates an isometric view of the foldable space heater in the locked state, in accordance with an embodiment of the present invention; and

FIG. 8 illustrates a method of operating the foldable space heater, in accordance with an embodiment of the present invention.

### DETAILED DESCRIPTION OF THE INVENTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is, therefore, not to be taken in a limiting sense, and the scope of the present invention disclosure is defined by the appended claims. Embodiments of the claims may, however, be embodied in many different forms and should not be construed as limited to the embodiments set forth herein.

The proposed foldable space heater is comprising of three main parts, herein named as a lower housing, an upper housing, and a telescopic pole. The telescopic pole mechanically connects the lower housing with the upper housing. A first hinge joint mechanically connects the telescopic pole with the upper housing. Similarly, a second hinge joint mechanically connects the telescopic poles with the lower housing. The lower housing can be placed on a wall surface or a ground surface. The weight of the lower housing is more than that of the telescopic pole and the upper housing, for maintaining the center of gravity point in a manner that the foldable space heater will remain in a static position and will not fall due to the inappropriate location of the center of gravity. In addition, the telescopic pole is also designed in a manner that most of the weight of the foldable space heater will remain towards the ground surface (when the foldable space heater is placed at the ground surface), which further aids in maintaining the center of gravity of the heater. Now, the upper housing is one of the main parts of the foldable space heater as the upper housing includes a heating element that provides heat to the space or the room. The heating element transfers the heat through conduction, convection, and radiation modes of heat transfer. However, the convection mode of heat transfer is dominant in transferring the heat to the room or the space. The upper housing also comprises a cut section which is equipped with wireless charging that charge an electronic device. The foldable space heater is equipped with a Bluetooth module, which allows the foldable space heater to connect with the electronic device. The electronic device allows the user to adjust the temperature of the foldable space heater as per the comfort of the user(s). Further, the upper housing is comprising a fan that ventilate the hot air from the foldable space heater to the ambient or nearby atmosphere of the foldable space heater through a plurality of holes crafted over the upper housing. Further, the telescopic pole is comprised of a plurality of hollow rods. The diameter at each ends of the hollow rods is variable. The hollow rod attached with the lower housing is of larger diameter and the hollow rod attached with the upper housing is smaller diameter. The smaller diameter hollow rod can be inserted into the consecutive larger diameter hollow rod for retracting the telescopic pole. When the user desires to collapse the foldable space heater, the user is required to push the smaller diameter hollow rod into the consecutive hollow rod with the large diameter for collapsing the foldable space heater. Further, an electric wire is passed through the telescopic pole from the lower housing to the heating element. The second hinge joint at the lower housing is a type of hollow rotational joint that eliminates the short circuit due to the bending of the wire during the folding of the foldable space heater. In addition, the first hinge joint allows the upper housing to pivot with respect to the telescopic pole. Similarly, the second hinge joint allows the telescopic pole to pivot with respect to the lower housing. Upon retracting and pivoting, the upper housing comes in direct contact with the lower housing. In the telescopic pole, a male connector is configured, and in the upper housing, a female connector is configured. Both the male connector and the female connector come in contact during the closing of the foldable space heater. Further, to unlock the upper housing from the lower housing, the user is required to apply an optimum amount of pull force on the upper housing and at same time hold the lower housing, which results in separation of the male connector from the female connector. Upon separating, the user can extend the telescopic pole for further user of the foldable space heater.

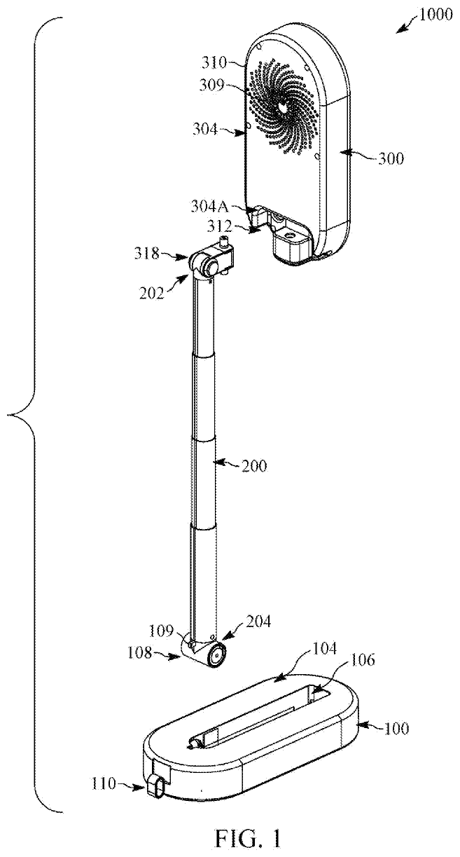

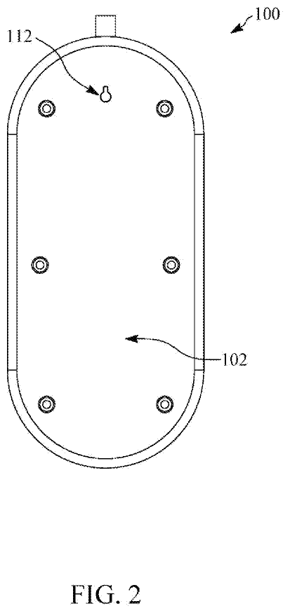

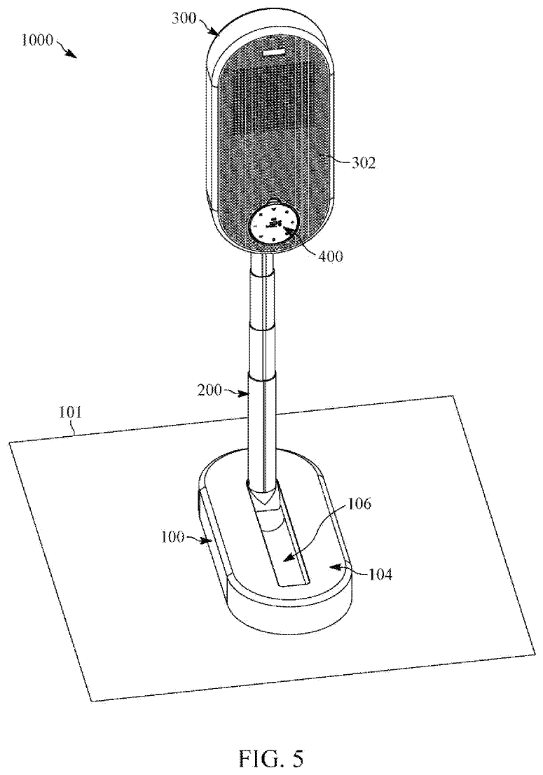

FIG. 1 illustrates an exploded view of a foldable space heater 1000 (hereinafter also referred to as “the heater 1000”), in accordance with an embodiment of the present invention. The proposed heater 1000 includes a lower housing 100, a telescopic pole 200, and an upper housing 300. In several embodiments of the invention, the lower housing 100 includes a base portion (See FIG. 2) which is facing toward a surface (See FIG. 5) which may be a wall surface or a ground surface. The lower housing 100 also includes a top portion 104 which is placed at a predetermined height from the base portion (See FIG. 2) opposite to the surface (See FIG. 5). The top portion 104 is crafted with a cavity 106. In several embodiments of the invention, the cavity 106 may be a T-shaped cavity or an I-shaped cavity. However, a person skilled in the art would appreciate that the cavity 106 may be given several other shapes such as circular, polygonal, etc. depending upon specific applications, without departing from the scope of the invention. Further, the dimensions of the cavity 106 i.e. at least a length, at least a width, and at least a depth, are larger than at least a length, a width, and a depth of the telescopic pole 200 when the telescopic pole 200 is in a completely retracted state. Further, a silicon piece 110 is attached with the lower housing 100, which is utilized by a user to hold the heater 1000.

The telescopic pole 200 extends away from the lower housing 100 in an upward direction. The telescopic pole 200 includes a top end 202 coupled to a first hinge joint 318 and a bottom end 204 coupled to a second hinge joint 108. Further, the bottom end 204 of the telescopic pole 200 is attached with the lower housing 100 through the second hinge joint 108. The second hinge joint 108 is preferably a hollow rotational joint which eliminates the chance of a short circuit in an electric wire that is passing through the second hinge joint 108, as the wire does not undergo bending during the folding of the heater 1000. The second hinge joint 108 is also utilized to provide pivoting motion to the telescopic pole 200 in order to bring the upper housing 300 in contact with the lower housing 100. In addition, a male connector 109 is configured over the telescopic pole 200 at some predetermined height from the second hinge joint 108, as shown in FIG. 1, utilized to lock the heater 1000.

The top end 202 is attached with a lower side of the upper housing 300 via the first hinge joint 318. The first hinge joint 318 herein enables the user to pivot the upper housing 300 with respect to the telescopic pole 200. Further, the electric wire is also passed through the first hinge joint 318 to provide electric current to a heating element present within the upper housing 300 without any tripping or damage to the electric wire.

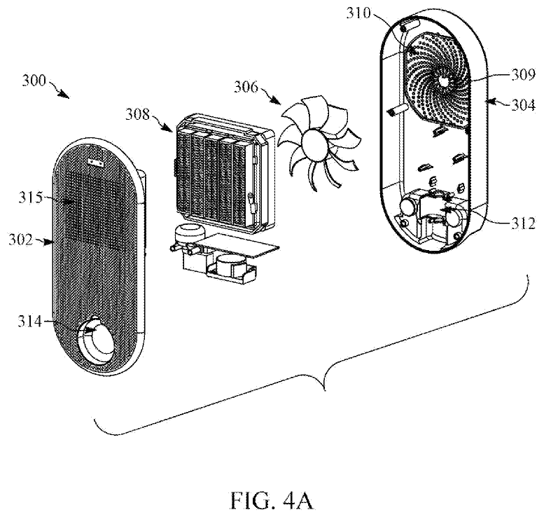

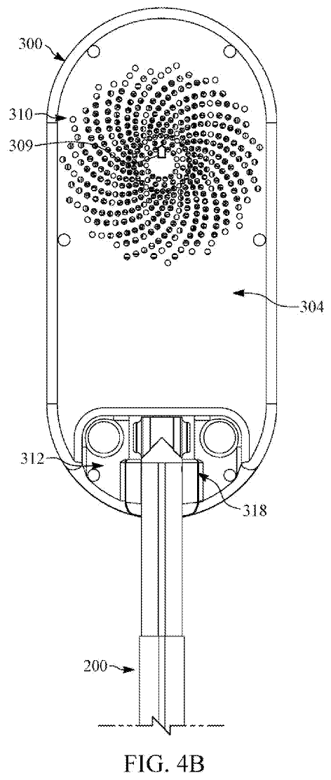

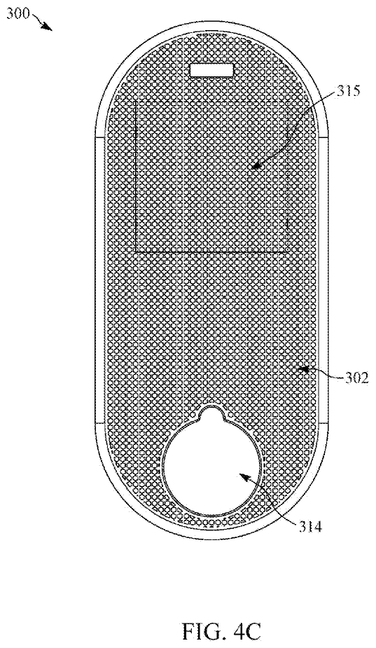

The upper housing 300 includes a front side (See FIG. 4A) and a rear side 304. The telescopic pole 200 is attached with a lower end 304A of the rear side 304. Further, the upper housing 300 in FIG. 1 includes a plurality of holes 310 which are crafted over the rear side 304. Each of the holes 310 allows the transfer of heat, which is produced by a heating element (See FIG. 4A) through radiation, conduction, and convection, while convection through air is the predominant mode of heat transfer. Furthermore, a female connector 309 is configured near the plurality of holes, as shown in FIG. 1 which comes in contact with the male connector 109 to lock the heater 1000. In addition, an inverted cavity 312 is crafted over the lower end 304A of the rear side 304 for attachment and pivoting movement of the first hinge joint 318.

FIG. 2 illustrates a rear view of the lower housing 100 of the foldable space heater 1000, in accordance with an embodiment of the present invention. In several embodiments of the invention, a hanging provision 112 is provided over the base portion 102 in order to hang the heater 1000 over the wall surface.

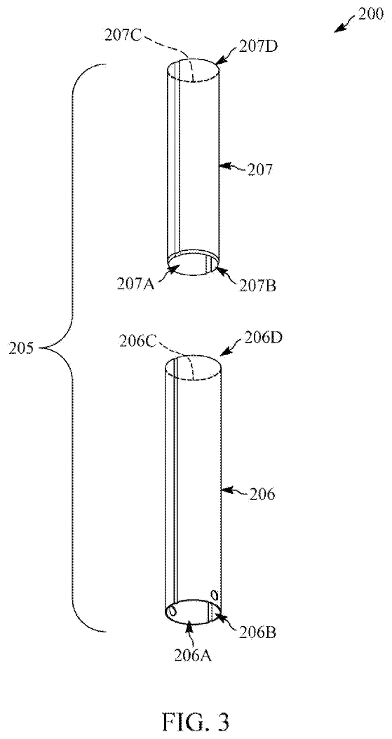

FIG. 3 illustrates an exploded view of the telescopic pole 200 of the foldable space heater 1000, in accordance with an embodiment of the present invention. In several embodiments of the invention, telescopic pole 200 includes a plurality of hollow rods 205. In that regard, the plurality of hollow rods 205 includes at least a first hollow rod 206 and at least a second hollow rod 207. The first hollow rod 206 includes a first hole 206A of a first diameter at a first end 206B. Also, the first hollow rod 206 includes a second hole 206C of a second diameter at a second end 206D. The first diameter is greater than the second diameter, and the first end 206B is attached to the lower housing 100.

Further, the second hollow rod 207 includes a third hole 207A of a third diameter at a third end 207B. Moreover, the second hollow rod 207 includes a fourth hole 207C of a fourth diameter at a fourth end 207D. The third diameter is smaller than the second diameter and the third end 207B is adapted to be inserted into the second hole 206C. The plurality of hollow rods 205 have tapered profiles with diameters gradually reducing while extending from the bottom end 204 to the top end 202. Further, each of the plurality of hollow rods 205 is hollow to enable the electric wire to pass through within the telescopic pole 200.

FIG. 4A illustrates an exploded view of the upper housing 300 of the foldable space heater 1000, in accordance with an embodiment of the present invention. As illustrated in FIG. 4A, the upper housing 300 includes the front side 302, the heating element 308, a fan 306, the first hinge joint 318, and the rear side 304. The front side 302 is crafted with a plurality of grills 315, and a cut section 314. The plurality of grills 315 are utilized to allow the heat and mass transfer to take place from the heating element 308 to the space or the room. The cut section 314 is equipped with a wireless charging. The user is required to place an electronic device (See FIG. 5) provided with a rechargeable battery, over the cut section 314 to charge the rechargeable battery which is provided within the electronic device (See FIG. 5). In several embodiments of the invention, the heating element 308 may include a heating filament or any other mean. The heating element 308 when powered by the electricity, provides heat. During heating of the heating element 308, in order to prevent the heating element 308 from being damaged due to high temperature, the fan 306 decreased the temperature of the heating element 308 by ventilating the excessive heat in the form of hot air towards rear side 304 of the upper housing 300 through the plurality of holes 310. In several embodiments of the present invention, in the predominant mode of heat and mass transfer, heat generated by the heating element 308 is absorbed by air molecules through conduction, convection, and radiation. Moreover, a forced or an induced draft generated by the fan 306 forces the heated air outwards to the room or the space to be heated. The heated air then transfers the heat to the air inside the space or the room through at least conduction and convection thereby increasing the temperature of the space or the room. The air inside the room also receives heat directly from the heating element 308 through infrared radiation emitted by the heating element 308. The heat and mass transfer may be directed to different regions of the space or the room by pivoting the upper housing 300 with respect to the telescopic pole 200 about the first hinge joint 318.

FIG. 4B illustrates a rear view of the upper housing 300 of the foldable space heater 1000, in accordance with an embodiment of the present invention. In several embodiments of the invention, the inverted cavity 312 is crafted over the lower end 304A of the rear side 304 to attach and/or movement of the first hinge joint 318. The inverted cavity 312 is utilized for providing space for the first hinge joint 318 to attach with the upper housing 300. Further, the plurality of holes 310 are provided over the rear side 304 of the upper housing 300, i.e., at the rear side 304, to allow air to enter into the upper housing 300 during the operation of the fan 306.

FIG. 4C illustrates a front view of the upper housing 300 of the foldable space heater 1000, in accordance with an embodiment of the present invention. As illustrated in FIG. 4C the upper housing 300 is provided with the plurality of grills 315 and the cut section 314 is shown. The plurality of grills 315 are utilized to allow the transfer of heat and heated air from the heating element 308 to the space or the room or the surroundings. The cut section 314 is equipped with wireless charging. The user is required to place the electronic device (See FIG. 5) over the cut section 314 to charge the rechargeable battery.

FIG. 5 illustrates an operational view of the foldable space heater 1000, in accordance with an embodiment of the present invention. As illustrated in FIG. 5, the heater 1000, when in operating mode or ready to operate, and is on the surface 101 is shown. It can be seen that both the first hinge joint 318 and the second hinge joint 108 are at the toggle position, i.e., at the extreme end position. At this position, the telescopic pole 200 is at a 90-degree angle with the lower housing 100 or at a 180-degree angle with the upper housing 300. The electronic device 400 acting as a user interface device is also shown in FIG. 5 in charging and in operating mode and is placed inside the cut section 314.

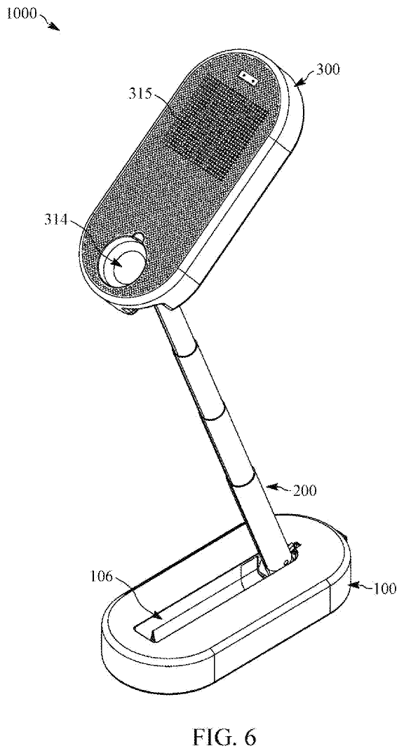

FIG. 6 illustrates another operational view at an angle of the foldable space heater 1000, in accordance with an embodiment of the present invention. As illustrated in FIG. 6, the heater 1000 when in operating mode or ready to operate is shown. As illustrated, both the first hinge joint 318 and the second hinge joint 108 are at respective predetermined angles. Furthermore, the telescopic pole 200 is at less than a 90-degree angle with the lower housing 100 and less than a 180-degree angle with the upper housing 300 but more than 90-degree with the upper housing 300. The electronic device 400 is not shown in FIG. 6 as the electronic device 400 is already charged and is operating the heater 1000 by increasing/decreasing the temperature of the space or the room through a wireless connection. The wireless connection herein includes a Bluetooth module via which the heater 1000 is wirelessly operated by the user from some distance.

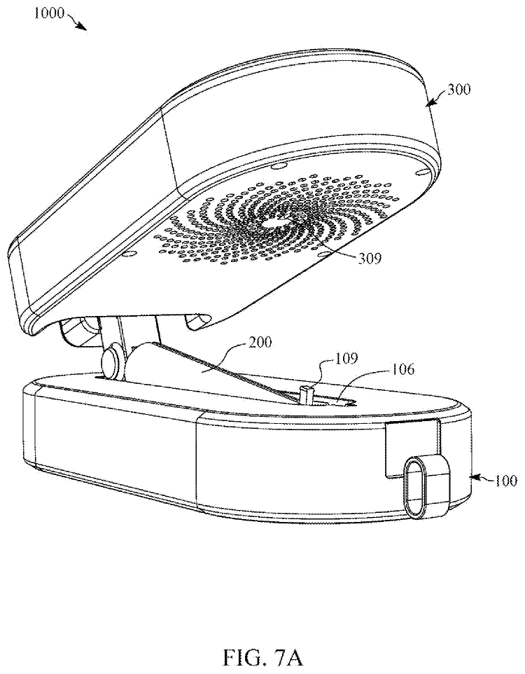

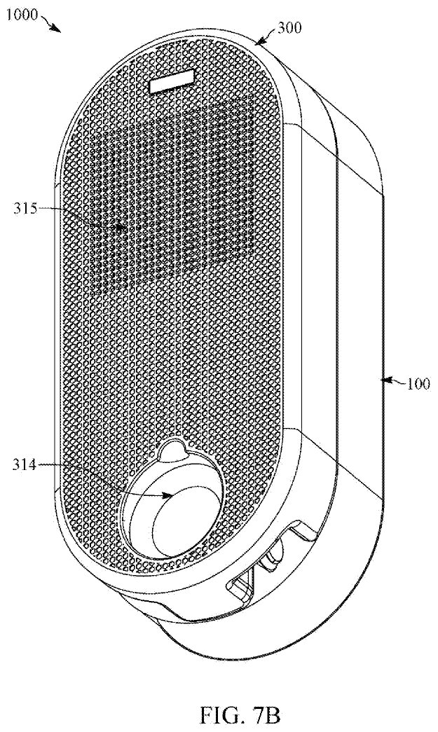

FIG. 7A illustrates an isometric view of the foldable space heater 1000 about to come in a locked state, in accordance with an embodiment of the present invention. In several embodiments of the invention, to close the heater 1000, the telescopic pole 200 needs to be retracted by the user and brings the upper housing 300 near to the lower housing 100. The upper housing 300 is configured with the female connector 309, while the telescopic pole 200 is configured with the male connector 109. Both the male connector 109 and the female connector 309 come in contact with each other to securely lock the heater 1000. The mechanism to lock the male connector 109 with the female connector 309 is frictional fit. In an alternate embodiment of the present invention, the mechanism to lock the male connector 109 with the female connector 309 is magnetic fit.

In an alternate embodiment of the present invention, the male connector 109 includes a protruded area over the tip of the male connector 109, which when comes in contact with the female connector 309, gets locked into the female connector 309 due to striking of the protruded area with a periphery of the female connector 309 which may be a ring shape or any other shape. The protruded area is made with elastic and soft material to easily fit inside the female connector 309.

In several embodiments of the invention, to unlock the heater 1000, the user is required to apply an optimum amount of pull force on the upper housing 300, and at the same time, the user needs to hold the lower housing 100 to generate opposite forces, thereby unlocking the heater 1000.

FIG. 7B illustrates an isometric view of the foldable space heater 1000 in the locked state, in accordance with an embodiment of the present invention. In several embodiments of the invention, the heater 1000 as shown in FIG. 7 is not in operating mode. The telescopic pole 200 is fitted inside the cavity 106 over the lower housing 100. In this position, the heater 1000 also becomes compact in size and shape.

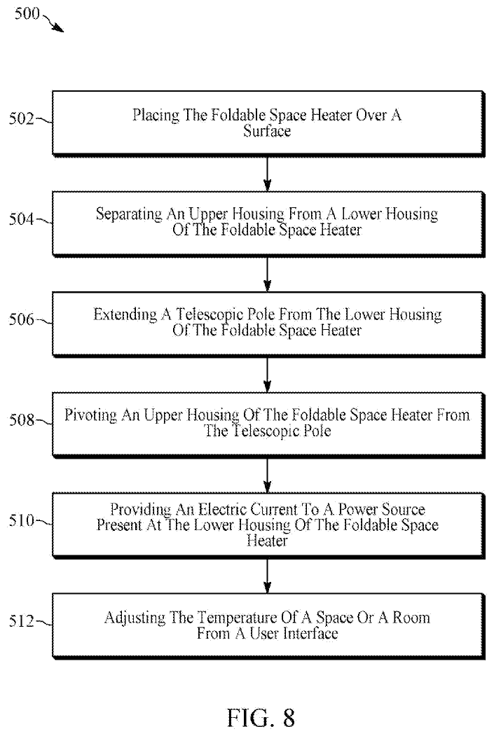

FIG. 8 illustrates a method 500 of operating the foldable space heater 1000, in accordance with an embodiment of the present invention. In several embodiments of the invention, the method 500 operating the heater 1000 includes several steps. The first step 502 is placing the foldable space heater 1000 over the surface 101. The foldable space heater 1000 is allowed to place over the wall surface or the ground surface or any table or any other mean. The second step 504 includes, separating the upper housing 300 and the telescopic pole 200 from the lower housing 100 of the foldable space heater 1000. The user is required to separate the upper housing 300 from the lower housing 100 via the second hinge joint 108 and the telescopic pole 200. The third step 506 includes, extending the telescopic pole 200 from the lower housing 100 of the foldable space heater 1000. The user is required to extend the telescopic pole 200 from the lower housing 100. The fourth step 508 includes, pivoting the upper housing 300 of the foldable space heater 1000 from the telescopic pole 200. The fifth step 510 includes, providing an electric current to a power source present at the lower housing 100 of the foldable space heater 1000. The sixth/last step 512 includes, adjusting the temperature of the space or the room from the electronic device 400 using the user interface provided on a display unit of the electronic device 400.

The invention as described above offers several advantages. For instance, the foldable space heater is very simple in design and construction. Further, the foldable space heater uses commonly available materials. The simplicity in design and construction, and the use of commonly available materials allow the foldable space heater to be mass-produced with minimal capital expenditure, and to be made available in the market at significantly lower prices. Also, the foldable space heater can be reused several times and is, therefore, cost-effective for the end user and minimizes waste generation.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to be providing the broadest scope consistent with the principles and the novel and inventive features disclosed or suggested herein. Accordingly, the invention is anticipated to hold on to all other such alternatives, modifications, and variations that fall within the scope of the present invention and appended claims.

1. A foldable space heater, the foldable space heater comprising:
a lower housing to be placed over a surface, the lower housing comprising:
a base portion facing towards the surface,
a top portion located at a predetermined height from the base portion, and
a cavity crafted over the top portion; and
a telescopic pole extending upwards from the lower housing, the telescopic pole comprising:
a top end attached with a lower side of an upper housing via a first hinge joint, the first hinge joint enables the upper housing to pivot with respect to the telescopic pole, and
a bottom end attached to the lower housing via a second hinge joint, the second hinge joint enables the telescopic pole to pivot with respect to the lower housing towards the cavity causing the upper housing to contact the lower housing.

2. The foldable space heater as claimed in claim 1, wherein the surface on which the lower housing is placed on a ground surface or a wall surface.

3. The foldable space heater as claimed in claim 1, wherein the cavity is a T-shaped cavity or an I-shaped cavity, and at least a length, a width, and a depth of the cavity is larger than at least a length, a width, and a depth of the telescopic pole when the telescopic pole is in a completely retracted state.

4. The foldable space heater as claimed in claim 1, wherein the telescopic pole comprises at least:
a first hollow rod comprising a first hole of a first diameter at a first end, and a second hole of a second diameter at a second end, the first diameter is greater than the second diameter, the first end attached to the lower housing;
a second hollow rod comprising a third hole of a third diameter at a third end, and a fourth hole of a fourth diameter at a fourth end, the third diameter greater than the second diameter, the third end adapted to be inserted into the second hole.

5. A foldable space heater, comprising:
a lower housing to be placed over a surface, the lower housing comprising:
a base portion facing towards the surface,
a top portion located at a predetermined height from the base portion, and
a cavity crafted over the top portion; and
a telescopic pole extending upwards from the lower housing, the telescopic pole comprising:
a top end attached with a lower side of an upper housing via a first hinge joint, the first hinge joint enables the upper housing to pivot with respect to the telescopic pole,
a bottom end attached to the lower housing via a second hinge joint, the second hinge joint enables the telescopic pole to pivot with respect to the lower housing towards the cavity to causing the upper housing to contact the lower housing,
wherein the upper housing includes a front side, a rear side, a fan, and a heating element,
wherein a plurality of grills is crafted over the front side to allow heat transfer from the heating element to a space or a room,
wherein a plurality of holes is crafted in the rear side to ventilate the hot air or radiation to the space, the room, or the ambient via the fan,
wherein an inverted cavity is crafted over a lower end of the rear side to attach and/or movement of the first hinge joint,
wherein a cut section is crafted over the front side, the cut section equipped with wireless charging, and
wherein an electronic device is provided over the cut section, the electronic device configured to operate the foldable space heater.

6. The foldable space heater as claimed in claim 5, wherein a male connector is configured over the telescopic pole, and a female connector is configured over the rear side of the upper portion to lock the heater.

7. The foldable space heater as claimed in claim 5, wherein an electric wire is passed through the telescopic pole and is electrically connected to the heating element.

8. The foldable space heater as claimed in claim 5, wherein a plurality of electronic items are placed in the lower housing to maintain a center of gravity of the foldable space heater closer to the surface.

9. The foldable space heater as claimed in claim 5, the plurality of electronic comprises a power source and a plurality of resistors.

10. The foldable space heater as claimed in claim 5, wherein the electronic device comprises a user interface, a rechargeable battery, and a plurality of buttons.

11. A method of using a foldable space heater, the method comprising the steps of:
a) placing the foldable space heater over a surface, wherein the foldable space heater comprises:
a lower housing, the lower housing comprising:
a base portion facing towards the surface,
a top portion located at a predetermined height from the base portion, and
a cavity crafted over the top portion; and
a telescopic pole, the telescopic pole comprising:
a top end attached with a lower side of an upper housing via a first hinge joint, the first hinge joint enables the upper housing to pivot with respect to the telescopic pole,
a bottom end attached to the lower housing via a second hinge joint, the second hinge joint enables the telescopic pole to pivot with respect to the lower housing towards the cavity to causing the upper housing to contact the lower housing,
wherein the upper housing includes a front side, a rear side, a fan, and a heating element,
wherein a plurality of grills is crafted over the front side to allow heat transfer from the heating elements to a space or a room,
wherein a plurality of holes is crafted in the rear side to ventilate the hot air to the space, the room, or the ambient via the fan,
wherein an inverted cavity is crafted over a lower end of the rear side to attach and/or movement of the first hinge joint,
wherein a cut section is crafted over the front side, the cut section equipped with wireless charging, and
wherein an electronic device is provided over the cut section, the electronic device configured to operate the foldable space heater;
b) separating an upper housing from a lower housing of the foldable space heater;
c) extending a telescopic pole from the lower housing of the foldable space heater;
d) pivoting an upper housing of the foldable space heater from the telescopic pole;
e) providing an electric current to a power source present at the lower housing of the foldable space heater; and
f) adjusting the temperature of a space or a room from the electronic device.

12. The method as claimed in claim 11, wherein the surface on which the lower housing is placed on a ground surface or a wall surface.

13. The method as claimed in claim 11, wherein the cavity is a T-shaped cavity or an I-shaped cavity, and at least a length, a width and a depth of the cavity is larger than at least a length, a width and a depth of the telescopic pole when the telescopic pole is in a completely retracted state.

14. The method as claimed in claim 11, wherein the telescopic pole comprising at least:
a first hollow rod comprising a first hole of a first diameter at a first end, and a second hole of a second diameter at a second end, the first diameter is greater than the second diameter, the first end attached to the lower housing; and
a second hollow rod comprising a third hole of a third diameter at a third end, and a fourth hole of a fourth diameter at a fourth end, the third diameter greater than the second diameter, the third end adapted to be inserted into the second hole.

15. The method as claimed in claim 11, wherein a male connector is configured over the telescopic pole, and a female connector is configured over the rear side of the upper portion to lock the heater.

16. The method as claimed in claim 11, wherein an electric wire is passed through the telescopic pole and is electrically connected to the heating element.

17. The method as claimed in claim 11, wherein a plurality of electronic items are placed in the lower housing to maintain a center of gravity of the foldable space heater closer to the surface.

18. The method as claimed in claim 11, the plurality of electronic comprises a power source and a plurality of resistors.

19. The method as claimed in claim 11, wherein the electronic device comprises a user interface, a rechargeable battery, and a plurality of buttons.
